(19) United States
(12) Patent Application Publication
(10) Pub. No.: US 2013/0118298 A1
(43) Pub. Date: May 16, 2013

(54) Drive Assembly

(71) Applicants: Tom Liakopoulos, West Dundee, IL (US); Norman R. Buggele, Hickory Hills, IL (US)

(72) Inventors: Tom Liakopoulos, West Dundee, IL (US); Norman R. Buggele, Hickory Hills, IL (US)

(73) Assignee: M-TEK, INC., Elgin, IL (US)

(21) Appl. No.: 13/295,849

(22) Filed: Nov. 14, 2011

(51) Int. Cl. F16H 53/00

(52) U.S. Cl. 74/567

(57) ABSTRACT

A cam is disclosed. The cam may include a body having an outer surface at a substantially constant diameter extending between a first end and a second end, a first path helically disposed inward from the outer surface, around the body in a first direction, wherein a first end of the first path is proximate the first end of the body, and a second path helically disposed inward from the outer surface, around the body in a second direction, wherein a first end of the second path is proximate the second end of the body.

### BACKGROUND OF THE INVENTION

1. Field of the Invention

The present invention is directed generally to the field of drive assemblies.

2. Description of the Related Art

Air driven jaws provide an air cylinder that opens and closes a jaw or a pair of jaws. This design has several inherent issues. For example, the jaw moves at one rate, the speed is limited, the control is limited, and the jaw opening is fixed.

Linkage style jaws generally are controlled by linkages that attach to an open elliptical “D” type lobe cam. These jaws have manual settings by varying the linkage lengths to facilitate completely closing the jaw or pair of jaws. These jaws further have fixed jaw openings and limited controls of closing times and dwells.

What is needed is a drive assembly that overcomes these drawbacks.

### SUMMARY OF THE INVENTION

In one aspect, a cam is disclosed. The cam may include a body having an outer surface at a substantially constant diameter extending between a first end and a second end, a first path helically disposed inward from the outer surface, around the body in a first direction, wherein a first end of the first path is proximate the first end of the body, and a second path helically disposed inward from the outer surface, around the body in a second direction, wherein a first end of the second path is proximate the second end of the body.

In another aspect, a cam system is disclosed. The cam system may include a cam having a body having a length and an outer surface at a substantially constant diameter extending between a first end and a second end, and a first path helically disposed inward from the outer surface, around the body in a first direction, wherein a first end of the first path is proximate the first end of the body. The cam further may have a second path helically disposed inward from the outer surface, around the body in a second direction, wherein a first end of the second path is proximate the second end of the body. The system also may include a follower configured to move within each of the first and second paths, such that the follower moves linearly along the length of the cam, and a first support arm and a second support arm, wherein the first support arm is disposed one side of the cam and the second support arm is disposed on a substantially opposite side of the cam.

In yet another aspect, a drive system is disclosed. The drive assembly may include a cam having a body having a length and an outer surface at a substantially constant diameter extending between a first end and a second end, a first path helically disposed inward from the outer surface, around the body in a first direction, wherein a first end of the first path is proximate the first end of the body, and a second path helically disposed inward from the outer surface, around the body in a second direction, wherein a first end of the second path is proximate the second end of the body. The assembly further may include a follower configured to move within each of the first and second paths, such that the follower moves linearly along the length of the cam, and a first support arm and a second support arm, wherein the first support arm is disposed on one side of the cam and the second support arm is disposed on a substantially opposite side of the cam, a first pair of shafts coupled to the first support arm configured to move in a first lateral direction, and a second pair of shafts coupled to the second support arm configured to move in a second lateral direction that is generally opposite of the first lateral direction.

These and other features and advantages are evident from the following description, with reference to the accompanying drawings.

### BRIEF DESCRIPTION OF THE SEVERAL VIEWS OF THE DRAWINGS

FIG. 1 is a perspective view of a system, having a gear box, including at least one jaw drive assembly therein.

FIG. 2 is a front view of the system of FIG. 1.

FIG. 3 is a cross-sectional view of the system of FIG. 2, along line A-A.

FIG. 4 is a cross-sectional view of the system of FIG. 2, along line B-B.

FIG. 5 is a cross-sectional view of the system of FIG. 3, along line C-C.

FIG. 6 is a perspective view of a helical gear shaft of the system of FIG. 1.

FIGS. 6A and 6B are side views of the gear shaft of FIG. 6.

FIG. 7 is a front view of a helical gear of the system of FIG. 1.

FIG. 7A is a cross-sectional view of the gear of FIG. 7, along line A-A.

FIG. 8 is a side view of a cam of the drive assembly of FIG. 1.

FIGS. 8A and 8B are additional side views of the cam of FIG. 8.

FIG. 9 is a cross-sectional view of a cam follower of the system of FIG. 1.

FIG. 10 is a top view of a cam follower housing of the system of FIG. 1.

FIG. 10A is a cross-sectional view of the follower housing of FIG. 10, along line A-A.

FIG. 11 is a bottom view of a first support arm of a jaw drive assembly, as shown in FIGS. 3-5.

FIG. 11A is a side view of the first support arm of FIG. 13.

FIG. 12 is a top view of a second support arm of a jaw drive assembly of FIG.

FIG. 12A is a side view of the second support arm of FIG. 14.

FIG. 13 is a perspective view of a shaft clamp that may be used with at least one of the first and second support arms of FIGS. 13 and 14.

FIG. 14 is a side view of a shaft of the drive assembly, as shown in FIGS. 3-5.

FIG. 14A is another side view of the shaft of FIG. 14.

### DETAILED DESCRIPTION OF THE INVENTION

While this invention is shown in the drawings and will be described in detail, several specific embodiments, with the understanding that the present disclosure is to be considered as an exemplification of the principles of the invention and is not intended to limit the invention to the embodiments illustrated.

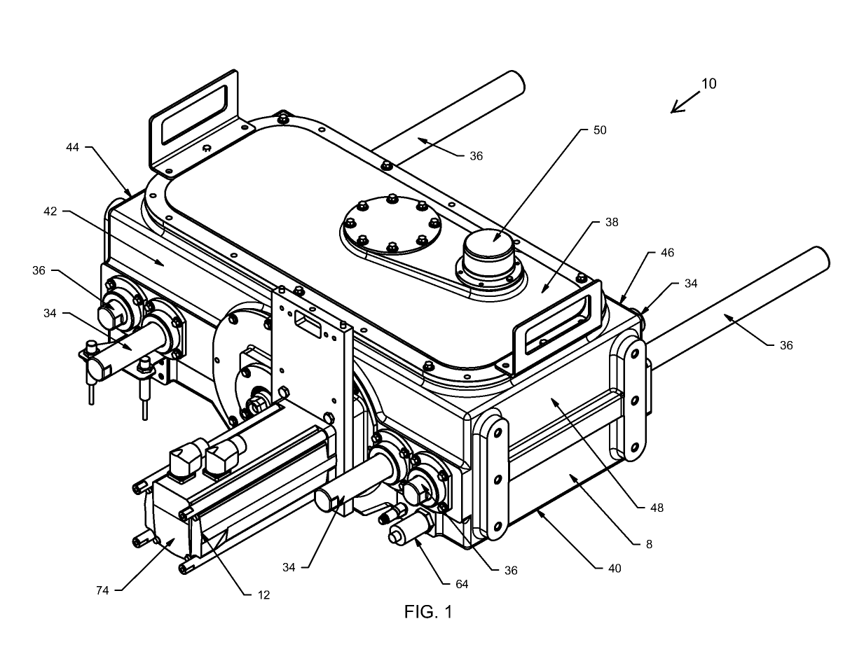

Turning to FIGS. 1-5, a drive assembly or jaw drive assembly 10 is disclosed that is configured to operate at least one pair of jaws between a first or open position and a second or closed position. Jaw drive assembly 10 may be encased in a gear casing or box 8 and may be driven by a motor, such that assembly 10 may convert rotary motion linear motion.

As described herein, assembly 10 may include a motor 12, a gear shaft 14, a gear 16, a cam or cam twin screw 18, at least one cam follower, and at least one support arm coupled to at least one pair of shafts. In one embodiment, cam 18 may be disposed substantially the same distance between each shaft of one pair of shafts.

In one embodiment, cam 18 has at least at two jaw paths defined therein, wherein each jaw path is configured to receive at least one cam follower 26 therein. Each cam follower 26 may move within a path and may be coupled to a separate support arm 30, 32, respectively, and each support arm 30, 32 may be coupled to a pair of shafts. Specifically, in one embodiment, a first support arm 30 is coupled to an inner pair of shafts 34 and a second support arm 32 is coupled to an outer pair of shafts 36. As each follower moves within a respective path, pair of shafts 34 may move in one linear direction and the other pair of shafts 36 may move in an opposite linear direction. This linear motion may facilitate moving a pair of jaws between the open and closed positions. The jaws may open a container, such as a bag, for filling, and once the container is filled, the jaws may move towards a closed position to close the container.

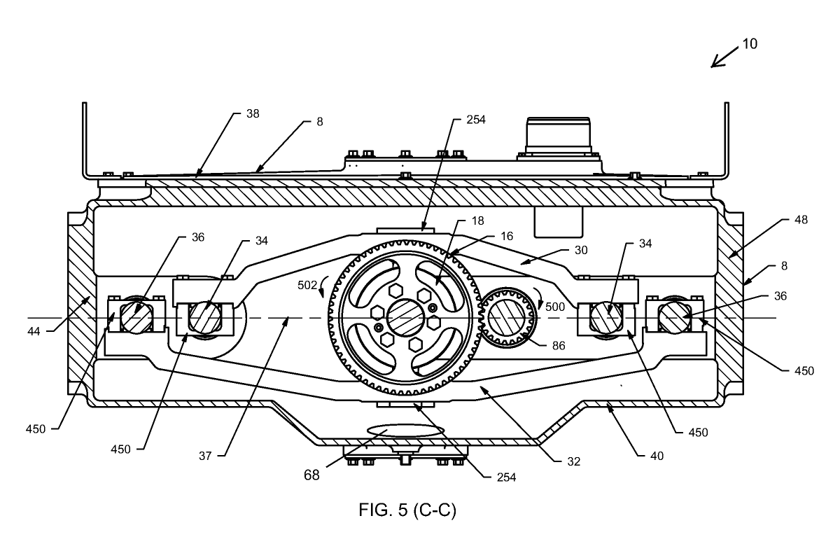

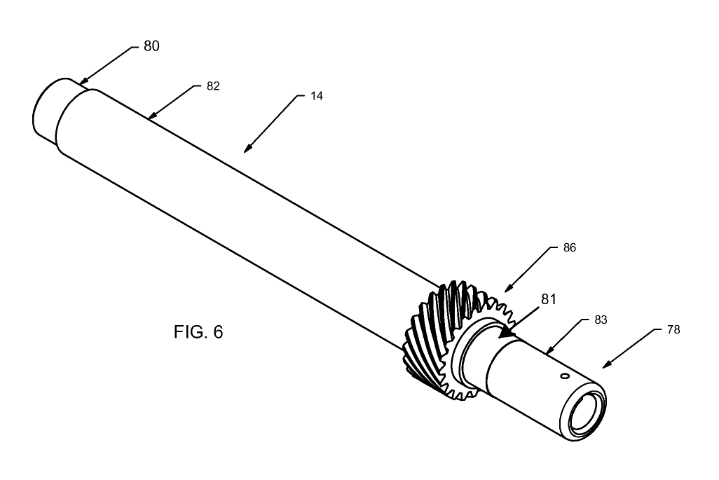

Turning to FIG. 5, a plane 37 that may be substantially parallel to a top 38 and bottom 40 may contain axes of rotation of cam 18, gear 86, shaft or gear shaft 14, gear 16, and/or shafts 34, 36, although one or more components may be offset from plane 37. For example, if one shaft 34 is offset from plane 37, then the other shaft of pair of shafts 34, preferably is offset by substantially the same amount.

Components of assembly 10 preferably are fabricated from stainless steel, with the exception of the cam, which preferably is fabricated from aluminum. Alternatively, components of assembly 10 may be fabricated from another suitable material that facilitates assembly and operation of assembly 10.

Additionally, components of assembly 10 may be coupled together with fastening mechanisms, such as screws, dowels, and other suitable mechanisms. Alternatively, components of assembly 10 may be coupled together with interference fits.

The cam, such as a barrel cam, design described herein is infinitely variable within a range for jaw openings, dwell times and speed of jaw cycle times. Further, the assembly has no user adjustments mechanically; therefore, a user can set dwell and closing times at a constraint variable if the need arises. These actions are all controlled via a program, such as software, for a servo drive motor and motion through a cam.

At least one key element of the design described herein is the cam and/or cam profile. The design of the cam motion is such that it allows the increasing jaw closure pressure to a substantially constant closing force with a variable dwell.

This new jaw assembly 10 significantly improves upon the current performance of other assemblies.

I. Gear Box 8

As shown in FIG. 1, gear box 8 may have top 38, bottom 40, and at least four sides 42, 44, 46, 48 extending between top 38 and bottom 40, and at least one handle coupled thereto.

In one embodiment, a tank filler and/or breather 50 may coupled to top 38 of box 8, such that a lubricant or oil, preferably a food grade oil, may be poured therethrough into box 8. The lubricant facilitates reducing friction and wear of the parts of assembly 10 during operation. Because the lubricant is used during operation of assembly 10 and may splash around inside box 8, box 8 may include a reservoir 51 formed within bottom 40 to collect the lubricant. Reservoir 51 may have a plurality of openings therein to facilitate the removal of the lubricant.

Box 8 may have a plurality of openings therein. Specifically, each side 42, 48 of box 8 may include at least four openings 52, 54, 56, 58 therein, so that shafts 34, 36 may extend between sides 42, 48. Side 42 further may include an opening 60 for motor 12 and an opening 62 for cam 18. In one embodiment, openings 52, 54, 56, 58, 60, 62 may be substantially the same size, may be round, and may be substantially collinear, along a line extending between a first edge 65 and an opposing second edge 67 of side 42. Openings 52, 54, 56, 58, 60, 62 should be sized to create an interference fit between a component of assembly 10, such as a shaft, and the respective opening. Alternatively, openings 52, 54, 56, 58, 60, 62 may be defined within any side, top or bottom of box 8, may not be substantially collinear and may have any size and shape.

Additionally, side 42 of box 8 further may include an opening 64 which is configured to receive for a temperature sensor 64 configured to monitor the temperature of the oil, and an opening 66 for a level detection sensor 68 configured to monitor the level of oil within the reservoir of box 8.

II. Jaw Assembly 10

A. Motor 12

As shown in FIGS. 1, 2, and 4, motor 12 may be configured to operate drive assembly 10. Motor 12 may be a servo motor, such as a BSH servo motor that may have low rotor inertia and may be configured for precision. Motor 12 may be compact and offer a high power density. Further, motor 12 may cover a substantially continuous stall torque range between about 0.5 Nm and about 50 Nm for nominal speeds between about 2500 and about 6000 rpm.

Motor 12 may be coupled to a plate 70 that facilitates coupling motor 12 to gear box 8. Preferably, in one embodiment, plate 70 is coupled to box 8 along side 42, using a plurality of fastening mechanisms, such as screws and/or at least one loaded seal spring 72.

Motor 12 may have a first end 74 and an opposing second end 76, wherein the second end 76 is configured to couple to shaft 14.

B. Gear Shaft 14 and Gear 86

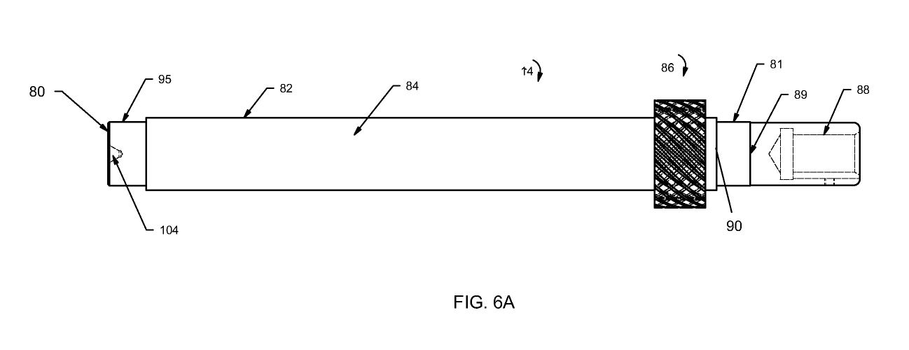

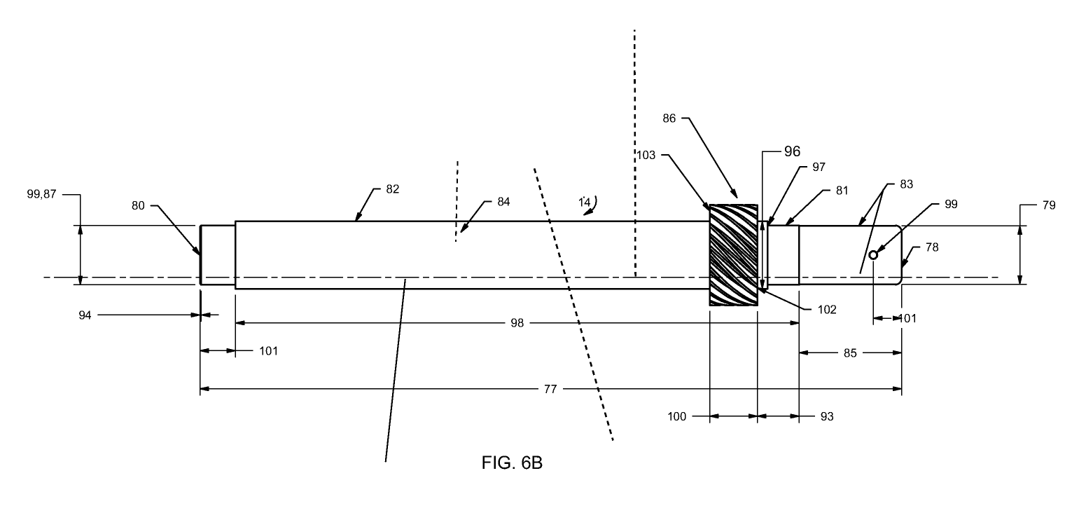

Turning to FIGS. 6 and 6A, gear shaft 14 may have a length 77 between a first end 78 and an opposing second end 80. Length 77 may be between about 6″ and about 24″ and preferably may be about 14.75″. Gear shaft 14 may be substantially cylindrical with at least one body portion 82 having an outer surface 84 and at least one gear 86 extending outwardly from surface 84.

As shown in FIG. 6A, shaft 14 may include a body portion 82, an extension portion 81, a first end portion 83, and a second end portion 95.

In one embodiment, end portion 83 is proximate first end 78 and may have a length 85 that may be between about 1″ and about 6″ and preferably may be about 2.15″ and a diameter 79 that may be between about 0.5″ and about 3″ and preferably may be about 1.234″. A bore 88 may be formed within end portion 83, wherein bore 88 is sized and configured to receive second end 76 of motor 12 therein. End portion 83 further may include at least one opening 99 therein. Opening 99 may be configured to receive a fastening mechanism therein to couple motor 12 and shaft 14 together. Opening 99 may extend from outer surface 84 inward to bore 88 and may be positioned a distance 101 from end 79. Distance 101 may be between about 0.1″ and about 3″ and preferably may be about 0.59″.

Portion 81 may be substantially solid and may have a first end 89 and a second end 91, wherein end 89 extends outward from end portion 83. Portion 81 may have a diameter 87, which may greater than diameter of end portion 83. Diameter 87 may be between about 1″ and about 6″ and preferably may be about 1.250″, and may have a length 93 between about 0.2″ and about 1″ and preferably may be about 0.660″.

Additionally, body portion 82 may be substantially solid and may have a diameter 84, which is greater than diameter 87, creating a step-up. This step-up from portion 81 to portion 82 creates a surface 97 to abut an inner surface of box 8. Diameter 84 may be between about 1″ and about 3″ and preferably may be about 1.420″. Shaft 82 may have a length 98, wherein length 98 may be between about 6″ and about 24″ and preferably may be about 11.187″.

Second end portion 95 may extend outward from body portion 82. Second end portion 95 may have a chamfer 94. Chamfer 94 may be about a 45 degree chamfer and may have a length between about 0.1″ and about 1″ and preferably about 0.30″. End portion 95 also may have a bore 104 therein. Portion 95 may have a diameter 99 between about 1″ and about 3″ and preferably may be about 1.250″, which may be less than diameter 84 and may be substantially the same as diameter 84. Further, end portion 95 may have a length 101. End portion 95 is configured to engage an inner surface of box 8.

Returning to FIG. 6, gear 86 may have a plurality of teeth that are configured to engage and/or interlock with teeth of gear 16. Gear 86 may extend radially outward from outer shaft 82. Additionally, gear 86 may have a width 100 extending between a first surface 102 and a second surface 103. In one embodiment, width 100 may be between about 0.5″ and about 2″ and preferably may be about 1 inch, and first surface 102 may be positioned a distance between about 0.1″ and about 2″ from surface 97, preferably the distance may be about 0.218″. Gear 86 also may have an outer diameter 105 between about 1″ and about 3″ and preferably about 2.180″.

In one embodiment, gear 86 has a pitch diameter of about 1.98 and a center distance of about 3.9604. In one embodiment, the helical angle is about 45 degrees, the pressure angle is about 14.5 degrees, the normal pitch is about 14.14, and there are about fourteen teeth. In one embodiment, gear 86 may have a pitch diameter of about 1.98 and a center distance of about 3.9604. Alternatively, gear 86 may have any number of teeth.

C. Gear 16

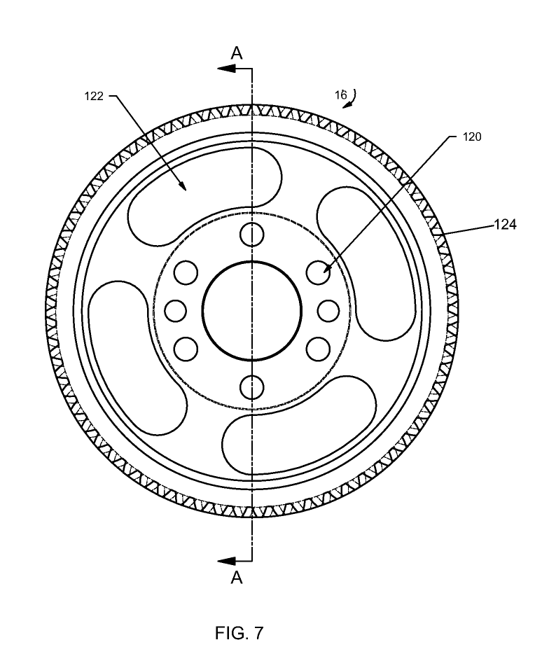

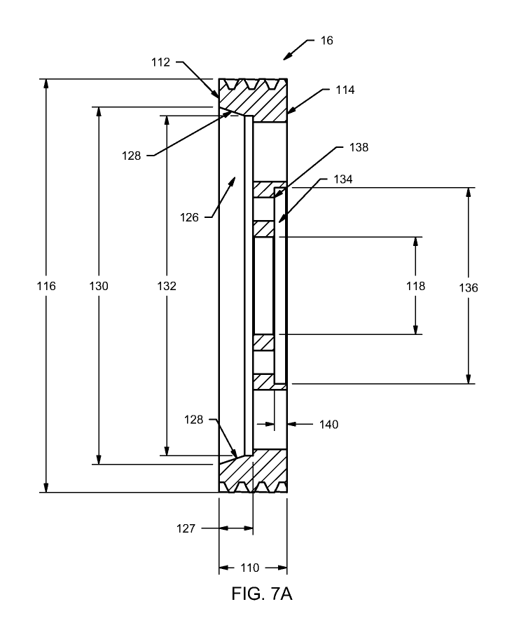

Turning to FIGS. 7 and 7A, gear 16 is configured to engage and/or interlock with gear 86 of gear shaft 14, such that rotating gear 86 facilitates rotating gear 86, preferably in an opposite direction. Gear 16 further may be configured to engage at least one end of cam 18.

Gear 16 may have an outer diameter 116 and an inner diameter 118 configured to engage cam 18. Outer diameter 116 may be between about 5″ and about 10″ and preferably about 6.140″, and inner diameter 118 may be between about 1″ and about 3″ and preferably about 1.437″.

Also, in one embodiment, outer diameter 116 of gear 16 is about three times greater than diameter 105 of gear 86. Gears 16 and 86 may be a set, wherein the set may have a ratio of about 3:1 to allow the motor to run at an optimal revolutions per minute (RPM) for correct heat dissipation, speed control, and torque.

Further, gear 16 may include a plurality of openings 120, which are radially outward of inner diameter 118, and which may be configured to receive fastening mechanisms to couple gear 16 to cam 18. Additionally, a plurality of openings 122 may be radially outward of openings 120. Openings 122 may be configured to reduce the weight of gear 16 without compromising the strength and/or rigidity of gear 16. In one embodiment, gear 16 includes about eight openings 120, each with a diameter between about 0.1″ and about 0.5″, preferably about 0.3″, and further includes about four openings 122, each having a substantially oblong shape. Moreover, a plurality of teeth 124 may be radially outward of openings 120 and 122.

In one embodiment, gear 16 has a helical angle of about 45 degrees, a pressure angle at about 14.5 degrees, a normal pitch of about 14.14, and about forty-two teeth 124. Further in one embodiment, gear 16 may have a pitch diameter of about 5.9397 and a center distance of about 3.9604″.

Additionally, as shown in FIG. 7A, gear 16 may have a width 110 extending between a first surface 112 and a second surface 114. In one embodiment, width 110 may be between about 0.5″ and about 1.5″ and preferably may be about 1″. Preferably, width 110 of gear 16 is substantially the same as width 100 of gear 86.

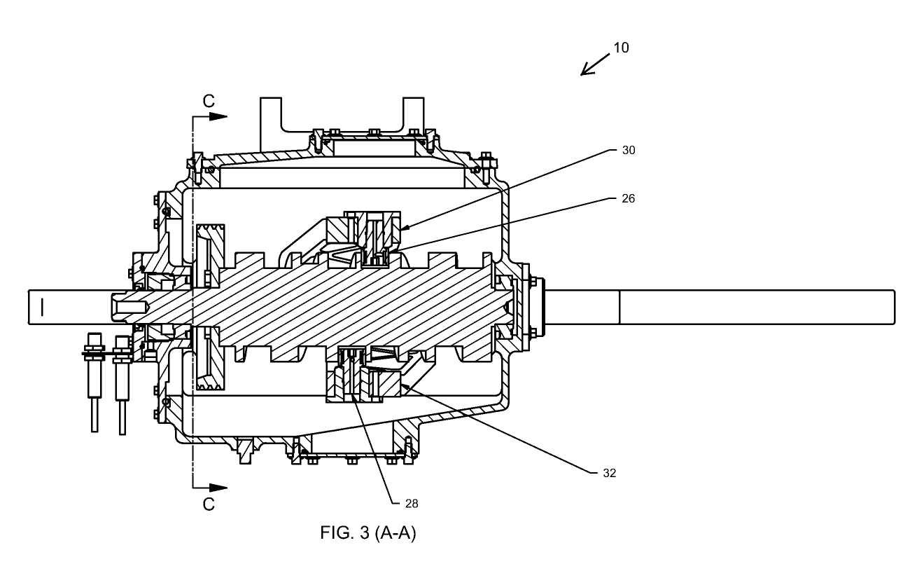

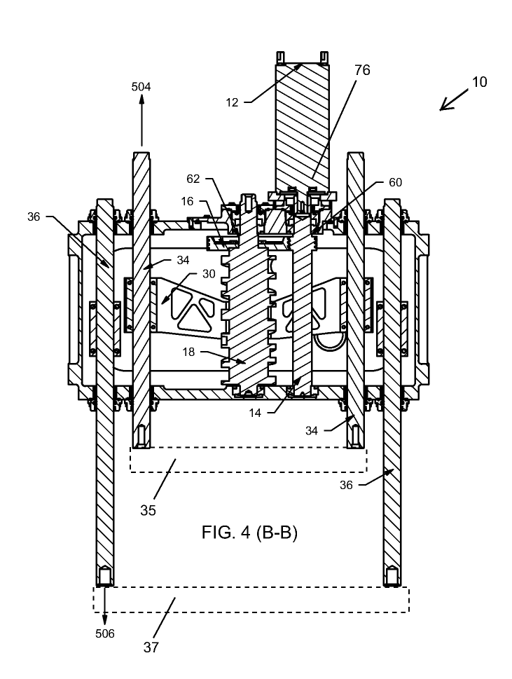

Surface 112 may have an opening 126 that may have a depth 127, which is less than width 110. Opening 126 may have a surface 128 that tapers or is angled inward. In one embodiment, opening 126 may have a diameter 130 between about 2″ and about 6″ and preferably about 5.25″, wherein diameter 130 is proximate surface 112, and tapers inward to a diameter 132 that may be between 2″ and about 6″ and preferably about 5″. As shown in FIGS. 3 and 4, opening 126 may reduce the weight of gear 16.

Returning to FIGS. 7 and 7A, surface 114 may have an opening 134 having a diameter 136. In one embodiment, diameter 136 may be between about 1″ and about 6″ and preferably may be about 2.880″. Opening 134 may be defined between surfaces 114 and a surface 138, such that opening 134 has a depth 140. Depth 140 may be between about 0.1″ and about 1″ and preferably may be about 0.187″. Opening 134 is configured to receive a portion of cam 18 therein for an interference fit between gear 16 and cam 18.

D. Cam 18

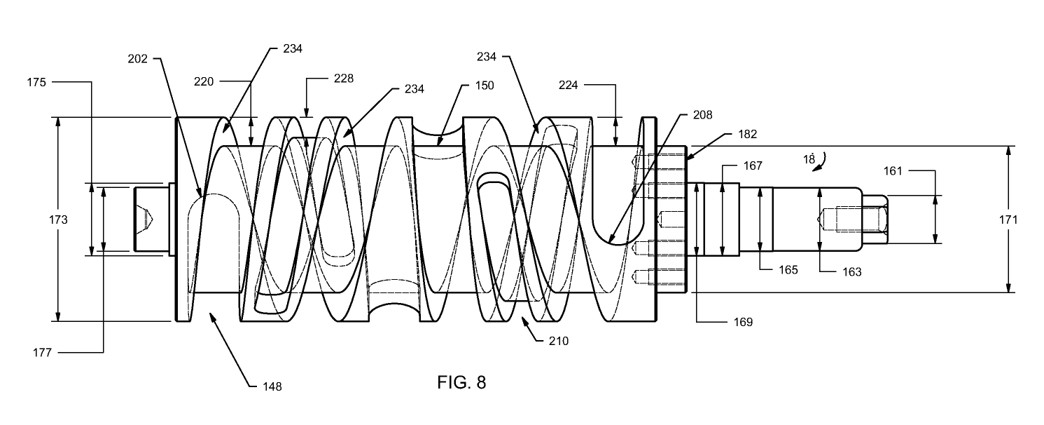

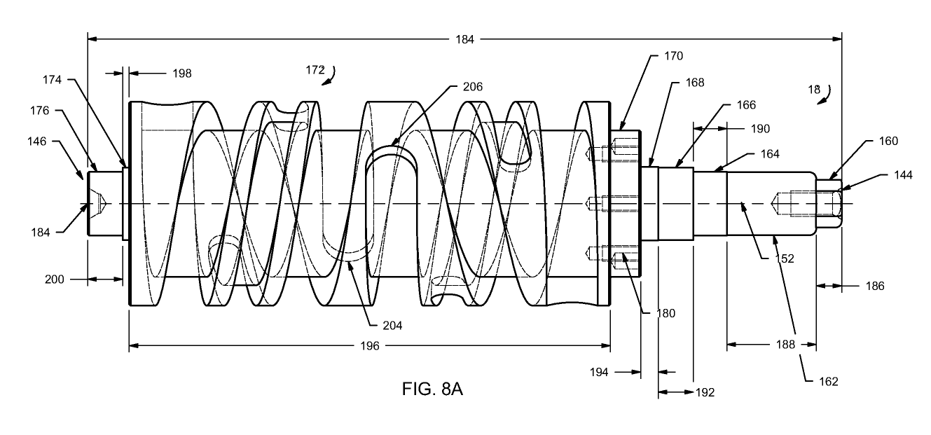

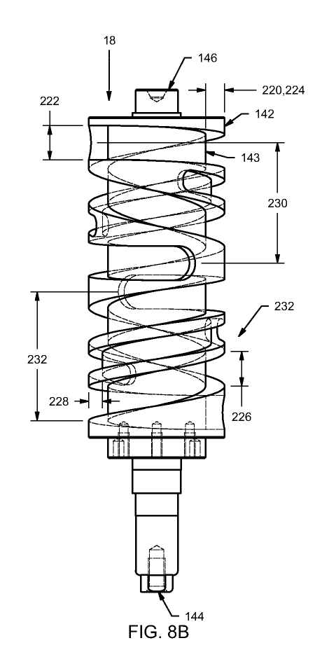

Turning to FIGS. 8, 8A and 8B, cam 18 may have a first end 144 and an opposing second end 146. Specifically, cam 18 may have a generally horizontal orientation with respect to box 8, wherein end 144 of cam 18 may be coupled to box 8 proximate side 42, and end 146 of cam 18 may be coupled to box 8 proximate side 46.

Cam 18 further may have at least two jaw paths, preferably a front jaw path 148 and a separate rear jaw path 150, defined therein. In a preferred embodiment, as shown in FIGS. 8, 8A and 8B, each jaw path is a substantially helical groove in an outer radial surface 142 of cam 18, such that each jaw path is configured to receive and guide a follower to move a pair of jaws smoothly and continuously between an open position and a closed position. This smooth motion will reduce wear on the jaws.

In an alternative embodiment, cam 18 may include one jaw path, rather than two, one cam follower to follow within the path, one cam follower housing coupled to the cam follower, one support arm coupled to the follower and housing, and one pair of shafts that translate in a linear direction.

In a further alternative embodiment, cam 18 may include one jaw path, such as path 148, and a second cam may include a second jaw path, such as path 150.

As shown in FIGS. 8, 8A and 8B, in one embodiment, outer radial surface 142 of cam 18 is generally cylindrical in shape, and each path or helical groove 148 and 150 extends around and inward from surface 142. Path 148 may be disposed in a first direction and path 150 may be disposed in a second direction, wherein the second direction may be opposite of the first direction. For example, the first direction may be clockwise and the second direction may be counterclockwise. Moreover, each path may have an inner radial surface 143. Each path 148, 150 may be axially spaced from one another on surface 142 and may extend circumferentially along surface 142 for a circumferential length. The circumferential length is selected to control and/or limit the distance that the follower may travel and therefore limit the distance that the jaws may open.

Cam 18 may include an end portion 160 configured to engage and/or extend through box 8 and may be substantially rectangular with a height and width. End portion 160 also may have a length 186, wherein length 186 may be between about 0.25″ and about 1″, and preferably about 0.5″. A lengthening portion 162 that may extend outward from end portion 160 and may have a diameter 163 that is greater than the height and/or width of portion 160. End portion 160 also may have a length 186. Moreover, a bore may be formed within portions 160 and 162, wherein the bore may be configured to receive a fastening mechanism therein.

A seal engaging portion 164 that may extend outward from portion 162 and may have a diameter 165 that is larger than the diameter 163. Portion 164 also may have a length 188, wherein length 188 may be about three times longer than length 186. In one embodiment, length 188 is between about 0.5″ and about 3″, and preferably about 1.75″.

An extension portion 166 that may extend outward from portion 164 and may have a diameter 167. Preferably, diameter 167 is greater than the diameter 165. Portion 166 also may have a length 190, that preferably is greater than length 186. Length 190 may be between about 0.25″ and about 1″, and preferably about 0.66″.

A first gear engaging portion 168 may be configured to engage gear 16. Portion 168 may extend outward from portion 166 and may have a diameter 169. Preferably, diameter 169 is greater than diameter 167. Portion 168 also has a length that may be about the same as length 190.

A second gear engaging portion or collar 170 also may be configured to engage gear 16. Portion 170 may extend outward from portion 168 and may have a diameter 171 that is greater than diameter 169. Portion 170 also may have a length 194 that may be between about 0.25″ and about 1″, and preferably may be about 0.343″.

A body portion 172 that may have at least one path and/or helical groove therein and may have a diameter 173. Diameter 173 may be substantially constant along body portion 172. Also, diameter 173 may be greater than diameter 171. Diameter 173 may be between about 1″ and about 12″, preferably between about 3″ and about 8″, and more preferably about 4″. Portion 172 also may have a length 196, wherein length 196 may be between about 2″ and about 12″, preferably between about 3″ and about 10″, and more preferably about 6.438″.

A second extension portion 174 may extend outward from portion 172 and may have a diameter 175 that is less than diameter 171. Diameter 175 may be substantially the same as diameter 167. Portion 174 also may have a length 198 that may be between about 0.05″ and about 1″, and preferably may be about 0.125″.

A second seal engaging portion 176 that may extend outward from portion 174 and may have a diameter 177 that is less than diameter 175 and may be substantially the same as diameter 165. Portion 176 also may have a length 200 that may be between about 0.25″ and about 1″, and preferably about 0.687″.

A bore 178 may be defined proximate first end 144 in portions 160 and 162, wherein bore 178 may be configured to receive at least one fastening mechanism therein. Additionally, a plurality of bores 180 are defined within a substantially planar surface 182 of portion 170, and may be positioned radially outward of portions 160, 162, 264, 166, 168. Each bore 180 may have an axis 183 that is substantially parallel to axis 152. Further, each bore 180 may correspond to an opening 120 of gear 16, and may be configured to receive a fastening mechanism therein to facilitate coupling gear 16 to cam 18. In one embodiment, plurality of bores 180 may be approximately 8 bores defined within surface 182. Also, bores 180 may have varying depths to receive different sized fasteners. Another bore 184 may be defined proximate second end 146. Bore 184 further may be configured to receive a fastening mechanism therein.

In one embodiment, as shown in FIG. 4, cam 18 is coupled directly to box 8 and gear 16 may be coupled to at least one portion 160, 162, 164, 166, 168 and/or 170, and gear 16 is coupled to gear 86 and shaft 14, which are then in communication with motor 12. In an alternative embodiment, at least one portion 160, 162, 164, 166, 168 and/or 170 of cam 18 may be coupled directly to motor 12.

Returning to FIGS. 8 and 8A, cam 18 has at least one path. For example, cam 18 may include paths 148, 150. Each path 148, 150 may guide at least one respective follower along a generally spiral or helical path, as cam 18 rotates about an axis 152. Path 148 may have a circumferential length around cam 18 of between about 0.5 turns to about 5 turns, preferably between about 0.75 turn to about 3.5 turns, more preferably about 2.25 turns, and path 150 may extend around cam 18 for between about 0.5 turns to about 5 turns, preferably between about 0.75 turn to about 3.5 turns, more preferably about 2.25 turns.

In one embodiment, at least one follower is inserted into each path 148 such that the follower may travel along path 148 between a first end 202 and a second end 204. Similarly, in one embodiment, at least one follower is inserted into each path 150 such that the follower may travel along path 150 between a first end 206 and stop proximate a second end 208. Path 148 may have a circumferential length 212 substantially defined between ends 202, 204, and path 150 may have a circumferential length 214 substantially defined between ends 206, 208. In one embodiment, circumferential lengths 212, 214 are substantially the same. Alternatively, circumferential lengths 212, 214 may be different to facilitate operation of assembly 10.

In addition to the circumferential lengths of paths 148, 150, each path 148, 150 may have an axial length 230, 232, respectively. Length 230, 232 may be between about 1″ and about 10″ and preferably about 3.547″.

In one embodiment, ends 202 and 208 may be diametrically opposite of one another. Alternatively, ends 202 and 208 may be positioned anywhere along surface 142.

Further, each path 148, 150 may be sized to receive a follower therein, such that the follower is configured to abut, contact and/or engage at least one wall 234 of each path 148, 150. Path 148 has a depth 220 defined between surfaces 142 and 143, and a width 222. In one embodiment, depth 220 may be generally constant and may be between about 0.1″ and about 1″ and preferably may be about 0.562″, and width 222 may be generally constant and may be between about 0.5″ and about 5″ and preferably may be about 1.003″. Similarly, path 150 may be sized to receive a follower therein, such that path 150 has a depth 224 defined between surfaces 142 and 143, and a width 226. In one embodiment, depth 224 may be generally constant and may be between about 0.1″ and about 1″ and preferably may be about 0.562″, and width 226 may be generally constant and may be between about 0.5″ and about 5″ and preferably may be about 1.003″. Although in one embodiment, depths 220, 224 are substantially the same and widths 222, 226 are substantially the same, in alternative embodiments, depths 220, 224 and widths 222, 226 may be different, such as to accommodate different followers.

Each path 148, 150 may have a pitch angle. For example, the pitch angle may be between about 1 degree and 20 degrees, preferably between about 3 degrees and 10 degrees, and more preferably about 5 degrees. Alternatively, paths 148, 150 may have pitch angles that are different from one another. The pitch angle may change the speed in which the cam follower travels within the path.

In one embodiment, the pitch angle does change. This is true at the beginning and end of each paths, which allows for jaw opening and/or closing dwell. Further, it allows a “coast point” should the servo motor need a range of degrees in rotation to stop.

Additionally, cam 18 may include at least one additional groove. As shown in FIG. 8, cam 18 may include two grooves 208, 210 wherein grooves 208, 210 are configured to remove excess weight from cam 18 to facilitate operation of assembly 10; however, grooves 208, 210 do not comprise the strength, rigidity or operation of assembly 10. In one embodiment, groove 208 is positioned between turns of path 148, and groove 210 is positioned between turns of path 150. Moreover, grooves 208, 210 may have a depth 228 of about 0.400″. Additionally, each groove 208, 210 may have a circumferential length that is less than one full turn around cam 18.

E. Cam Follower 26 and Housing 254

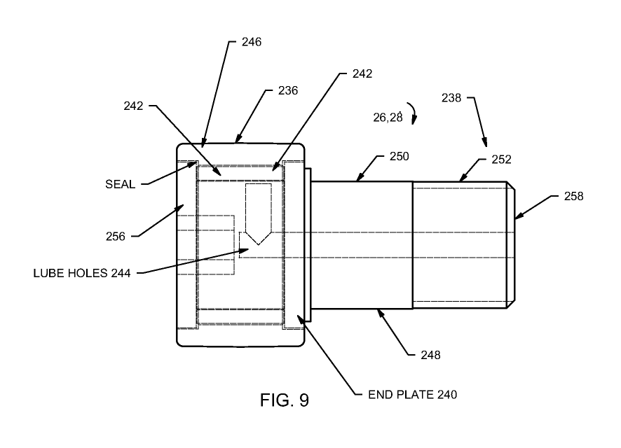

Turning to FIG. 9, assembly 10 may include at least one cam follower 26. A follower 26 may be configured to engage with and follow within path 148, and similarly, a second follower may be configured to engage with and follow within path 150. Follower 26 may be a specialized type of roller or needle bearing.

Follower 26 may have a head portion 236 and an engaging portion 238 extending outward therefrom, such that portions 236 and 238 may be substantially perpendicular to one another. When follower 26 and cam 18 are coupled together, portion 236 is configured to engage wall 234 of cam 18 and portion 238 is configured to extend outward therefrom. Specifically, when follower 26 and cam 18 are coupled together, a first end 256 is configured to be substantially flush with path 148, 150, and an opposing second end 258 is configured to substantially flush with a

In one embodiment, head portion 236 is configured to fit within a path 148, 150, and head portion 236 may include at least one end plate 240, rollers 242 that may be substantially perpendicular to end plate 240, lubrication openings 244, and an outer race 246.

In one embodiment, portion 238 has a radially outer surface 248 with a first substantially smooth portion 250 and a second threaded portion 252 configured to engage a cam follower housing 254.

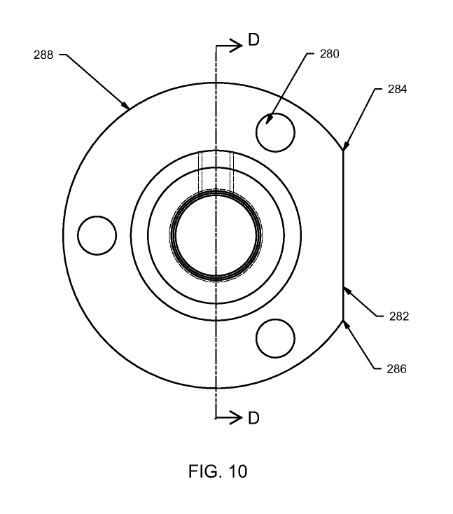

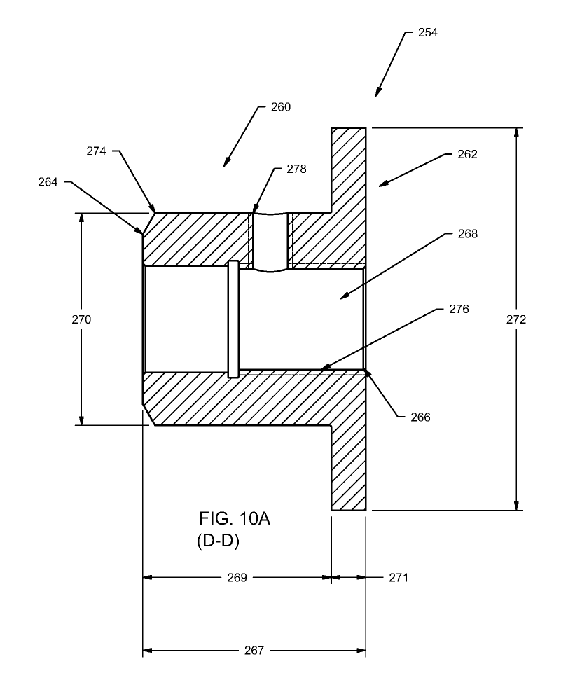

Turning to FIG. 10, each cam follower housing 254 may be configured to engage follower 26 and also engage at least one support arm 30, 32. Each housing 254 may have a body 260 and a flanged portion 262 that is substantially perpendicular to body 260, a first end 264 and a second opposing end 266, and a bore 268 extending substantially through housing 254 between ends 264 and 266. Bore 268 may have threading therein configured to engage threading of follower 26.

Housing 254 may have a length 267 defined between ends 264 and 266. Length 267 may be between about 0.5″ and about 3″ and preferably about 1.31″. Body 260 may have a first diameter 270 and portion 262 may have a second diameter 272 that is greater than diameter 270. For example, diameter 270 may be between about 1″ and about 3″ and preferably about 1.25″, and diameter 272 may be between about 1″ and about 5″ and preferably about 2.25″. In one embodiment, flanged portion 262 is not arcuate around an entire circumference, but rather may have a substantially straight edge 282 having a first end 283 and a second end 286 and a substantially arcuate edge 288 extending between ends 283 and 286. Also, in one embodiment, body 260 also may have a length 269 that is between about 0.1″ and about 1″ and preferably may be about 0.201″, and flanged portion 262 may have a length 271 that is between about 0.5″ and about 3″ and preferably may be about 1.109″. Additionally, body 260 may have a radially outer surface 274 and a radially inner surface 276 and a bore 278 extending between surfaces 274 and 276.

In one embodiment, end 258 of cam follower may be inserted into end 264 of housing 254, threaded portion of housing 254 may engage threaded portion 252, and a fastening mechanism may be inserted into bore 278 to facilitate coupling follower 26 and housing 254.

Additionally, flanged portion 262 may have at least one opening 280 configured to receive a fastening mechanism therein, such that this fastening mechanism is configured to couple support arm and housing 254 together.

F. Support Arms 30, 32

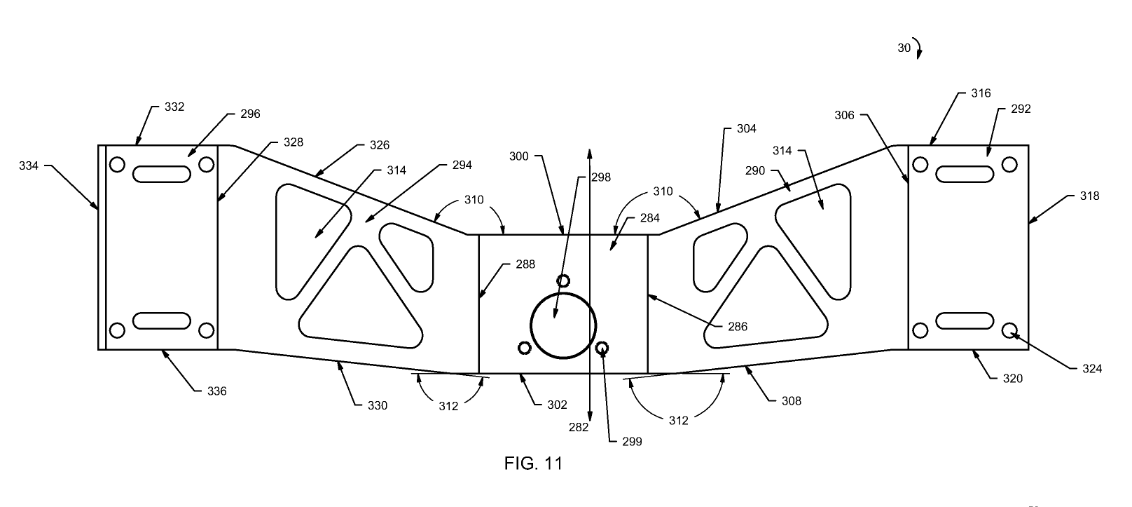

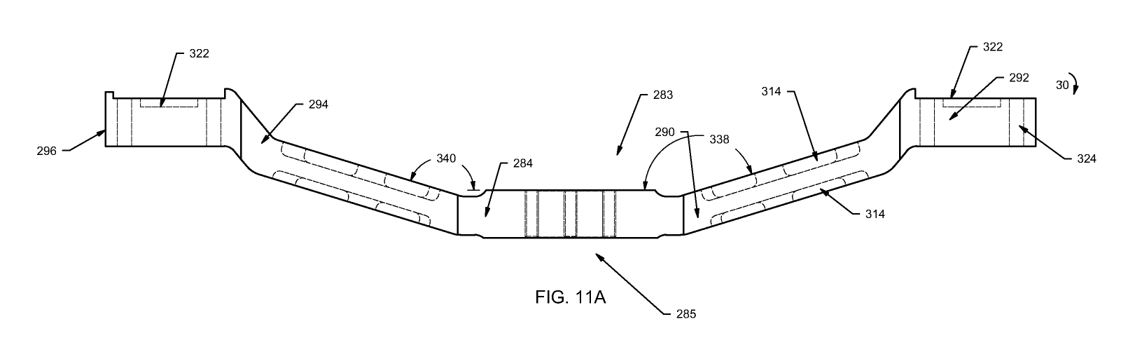

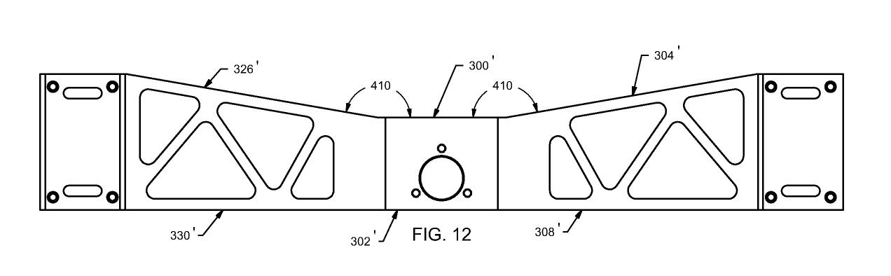

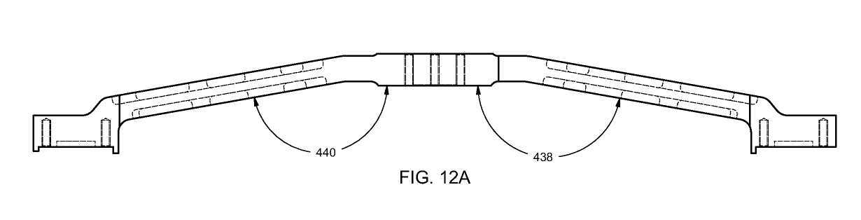

Turning to FIGS. 11, 11A, 12 and 12A, assembly 10 may include at least one support arm. In one embodiment, assembly 10, as shown in FIG. 5, may include an upper support arm 30 configured to be positioned above or on one side of cam 18 and a lower support arm 32 configured to be positioned below or on a substantially opposite side of cam 18. Support arm 30 may be configured to couple to and move at least one pair of shafts, such as inside shafts 34, and support arm 32 may be configured to couple to and move at least one pair of shafts, such as outside shafts 36.

As shown in FIGS. 11 and 11A, support arm 30 may have an axis 282, a first surface 283, a second surface 285, and a thickness therebetween. In one embodiment, support arm 30 may be substantially symmetrical around axis 282. Support arm 30 may include a follower engaging portion 284, at least one extension portion, and at least one shaft engaging portion.

In one embodiment, as shown in FIG. 11, support arm 30 includes a portion 284 having edges 286, 288, a first extension portion 290 extending outward from each edge 286, a first shaft engaging portion 292 extending outward from portion 290, a second extension portion 294 extending outward from edge 288, and a second shaft engaging portion 296 extending outward from portion 294.

Follower engaging portion 284 may have an opening 298 therein, wherein opening 298 is configured to receive portion 260 of cam follower housing 254 therein. In one embodiment, opening 298 has a threaded inner surface. Portion 260 may be inserted into opening 298 and portion 262 of follower 254 may be positioned substantially flush with surface 283 of arm 30. Further, in one embodiment, housing engaging portion 284 may be substantially rectangular having edges 282, 300, 286, 302. Opening 298 may be substantially centered between opposing edges 282, 286, but may not be substantially centered between opposing edges 300, 302. Rather, opening 298 may be closer to edge 302 than edge 300. Further, a plurality of openings 299 may be spaced radially outward from opening 298, such that openings 299 are configured to receive fastening mechanisms therein to facilitate coupling housing 254 to arm 30.

First extension portion 290 may extend outward and upward from portion 284. First extension portion 290 may share edge 286 with portion 284 and further has edges 304, 306, 308. Edges 300, 304 may form an angle 310 therebetween, and similarly, edges 302, 308 may form an angle 312 therebetween. In one embodiment, angle 310 may be an obtuse angle that is between about 150 degrees and about 170 degrees and preferably may be about 160 degrees, and angle 312 also may be an obtuse angle that is between about 150 degrees and about 170 degrees and preferably may be about 175 degrees, such that angle 312 is greater than angle 310. Edges 304, 308 may be angled with respect to edges 300, 302, respectively, to prevent interference between support arm 30 and box 8 during operation. Additionally, each extension portions 290, 294 may have a plurality of indentations 314 formed within surfaces 283 and 285 to remove weight from portion 290. As shown in FIG. 11A, each portion 290, 294 may have at least three indentations 314.

First shaft engaging portion 292 may extend outward from portion 290. In one embodiment, portion 292 is substantially rectangular, shares edge 306 with portion 290, and further has edges 316, 318, 320. Shaft engaging portion 292 may have an indentation 322 therein, wherein indentation 322 may be configured to receive a shaft therein. Additionally, portion 292 may include at least one opening 324 therein, wherein opening 324 may be configured to receive a fastening mechanism therein to couple a shaft clamp 450 to arm 30.

Similarly, second extension portion 294 may extend outward and upward from portion 284. Portion 294 may share edge 282 with portion 284 and further has edges 326, 328, 330. Edges 300, 326 may form angle 310 therebetween, and similarly, edges 302, 330 may form angle 312 therebetween. Edges 326, 330 may be angled with respect to edges 300, 302, respectively, to prevent interference between support arm 30 and box 8 during operation. Additionally, portion 294 may have a plurality of indentations 314 formed within surfaces 283 and 285 to remove weight from portion 290.

Portion 296 may extend outward from portion 294. In one embodiment, portion 296 is substantially rectangular, shares edge 328 with portion 294, and further has edges 332, 334, 336. Shaft engaging portion 296 may have indentation 322 therein, wherein indentation 322 may be configured to receive a shaft therein. Additionally, portion 296 may include at least one opening 324 therein, wherein opening 324 may be configured to receive a fastening mechanism therein to couple a shaft clamp to arm 30.

Additionally, as shown in FIG. 11A, in one embodiment, portions 284, 292, 296 of support arm 30 are substantially parallel to one another, with portions 292, 296 being substantially coplanar. Portions 284, 290, 294 may not be coplanar. Rather, each portion 290, 294 may form an angle 338, 340, respectively, with portion 284. Angles 338, 340 are configured to prevent interference between cam 18, arm 30 and/or shafts 34, 36. In one embodiment, angles 338, 340 may be obtuse angles. For example, angles 338, 340 may be between about 150 degrees and about 170 degrees and preferably may be about 160 degrees. Alternatively, angles 338, 340 may be any suitable angle.

Further, in one embodiment, arm 30 may have an overall length between edges 318 and 334 that is between about 6″ and about 24″, and preferably may be about 18.250″.

Turning to FIGS. 12 and 12A, arm 32 is substantially the same as that of arm 30 (FIGS. 11, 11A), except for the size, specifically the overall length between edges 318′ and 334′ may be greater in arm 32 than arm 30, and the angles of arm 32 may be sized differently than angles of arm 30, as discussed further herein. Therefore, the portions, indentations, openings, bores and other components of arm 30 which are similar or identical to corresponding components of arm 32 are provided with like reference numerals, augmented by a prime (').

As shown in FIGS. 12 and 12A, edges 300′, 304′ may form an angle 410 therebetween. In one embodiment, angle 410 may be an obtuse angle that is between about 150 degrees and about 180 degrees and preferably may be about 170 degrees. Similarly, edges 300′, 326′ for angle 410 therebetween. Edges 308′, 330′ may substantially collinear with edge 302′. Edges 304′, 326′ may be angled with respect to edge 300′ to prevent interference between support arm 32 and box 8 during operation. Additionally, each extension portion 290′, 294′ may have a plurality of indentations 314′ formed within surfaces 283′ and 285′ to remove weight from portion 290′. As shown in FIG. 12A, each portion 290′, 294′ may have at least four indentations.

Further, in one embodiment, arm 32 may have an overall length between edges 318′ and 334′ that is between about 6″ and about 24″, and preferably may be about 23.625″. Arm 32 may be longer than arm 30 so that arm 32 may reach outer shafts 36.

Shafts 34 are configured to be positioned proximate indentations 322 and shafts 36 are configured to be positioned proximate indentations 322′. Specifically, shafts 34, 36 may be substantially parallel to edges 318, 334, 318′, 334′.

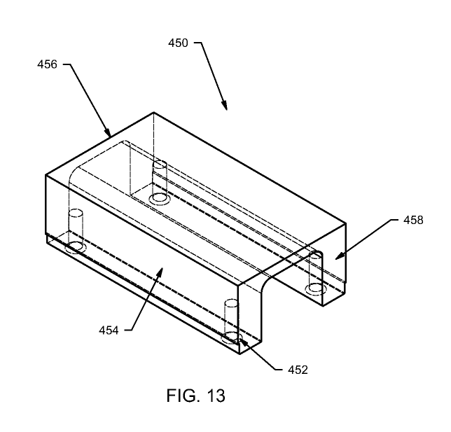

Turning to FIG. 13, a shaft clamp 450 may be configured to couple to each portion 292, 296, 292′, 296′ to substantially surround at least one shaft 34, 36. Each shaft clamp 450 may act as a housing and facilitate retaining shafts 34 proximate indentations 322 and shafts 36 proximate indentations 322′.

In one embodiment, clamp 450 is sized substantially the same as portions 292, 296, 292′, 296′. Additionally, clamp 450 may have a plurality of bores 452 therein. Bores 452 are configured to align with openings 324. Clamp 450 may have a first wall 454, a top wall 456, and a second wall 458, wherein walls 454, 458 are substantially perpendicular to wall 456.

G. Pair of Shafts 34, 36

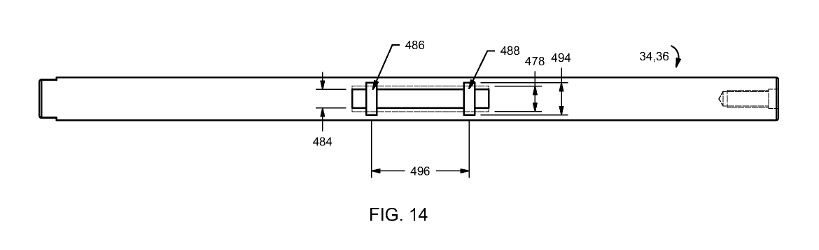

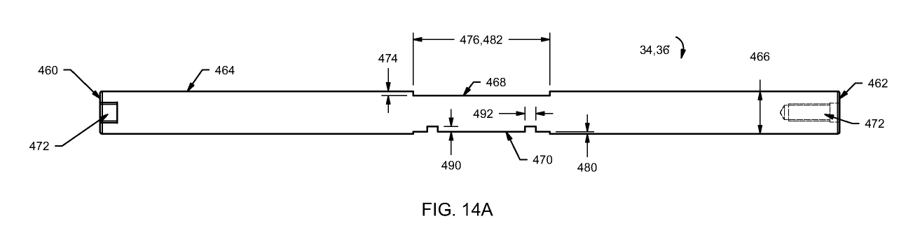

Turning to FIGS. 14 and 14A, assembly 10 may include a plurality of shafts. Specifically, as shown in FIG. 5, assembly 10 includes two pairs of shafts 34, 36. Shafts 34, 36 are configured to move a pair of jaws towards and away from one another—between an open position and a closed position. An inner pair of shafts 34 is configured to move one jaw of the pair of jaws and an outer pair of shafts 36 is configured to move the other jaw.

Each shaft 34 may have a first end 460, a second end 462, and a body 464 extending therebetween. Body 464 may be substantially cylindrical with a diameter 466. Body 464 may have at least one indentation therein. Indentations are configured to facilitate coupling clamp 450 and an arm 30, 32 with a shaft 34, 36. In one embodiment, shown in FIGS. 14 and 14A, body 464 may have two diametrically opposite indentations 468, 470. Indentations 468, 470 may be substantially centered between ends 460, 462, and each indentation 468, 470 may be substantially rectangular in shape. In one embodiment, indentation 468 has a depth 474 that may be between about 0.05″ and about 1″ and preferably may be about 0.1″, and has a length 476 that may be between about 1″and about 6″ and preferably may be about 4.020″, and further has a width 478 that may be between about 0.2″ and about 1″ and preferably may be about 0.6″. Further, in one embodiment, indentation 470 has a depth 480 that may be between about 0.05″ and about 1″ and preferably may be about 0.07″, and has a length 482 that may be between about 1″ and about 6″ and preferably may be about 4.020″, and further has a width 484 that may be between about 0.2″ and about 1″ and preferably may be about 0.5″. Further, indentation 470 may include cross indentations 486, 488 that may be substantially rectangular in shape and may be substantially perpendicular to indentation 470. In one embodiment, cross indentations 486, 488 has a depth 490 that is between about 0.1″ and about 0.5″ and is preferably about 0.156″, and has a length 492 that is between about 0.1″ and about 0.5″ and is preferably about 0.3125″, and further has a width 494 that is between about 0.1″ and about 1″ and is preferably about 0.7″ Additionally, in one embodiment, cross indentations 486, 488 may be spaced a distance 496 apart, wherein distance 496 may be between about 1″ and about 6″ and preferably may be about 2.875″.

Moreover, shaft 34 may include at least one bore 472 in each end 460, 462. Bore 472 may be configured to receive a fastening mechanism therein.

Each shaft 36 is substantially the same as each shaft 34, with the exception of size. In one embodiment, shaft 36 may be longer than shaft 34 and may include larger openings.

### II. OPERATION

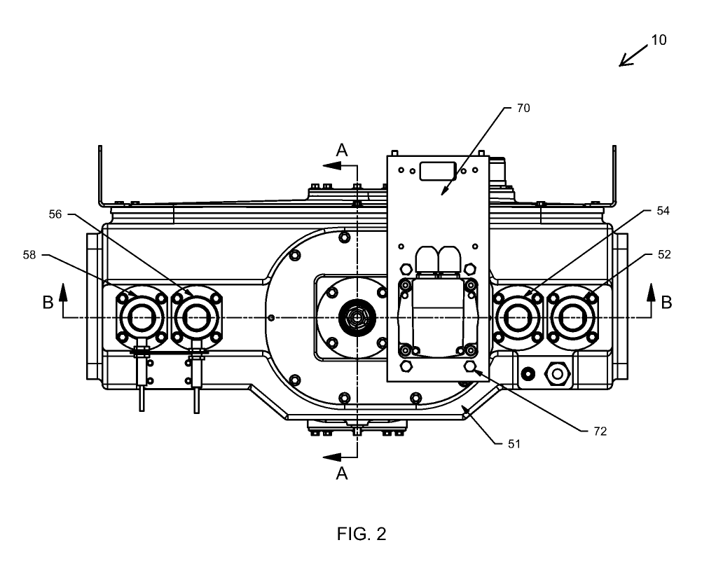

During operation, as shown in FIGS. 2-5, assembly 10 converts rotary motion to linear motion to move at least one pair of jaws between an open position and a closed position. In the open position, a bag or other item may be open to be filled with a product and in the closed position, the jaws close the bag or other item.

Motor 12 operates to rotate shaft 14 and gear 68 in a first direction 500 to rotate gear 16 in an opposite direction 502. As gear 16 turns in direction 502, cam 18 rotates along with gear 16. Alternatively, motor 12 also may operate to rotate shaft 14 and gear 68 in direction 502, such that gear 16 rotates in direction 500.

As cam 18 rotates, a cam follower 26 may move within each path 148, 150, respectively. Specifically, cam follower 26 and corresponding housing 254 may move between bounded ends 202, 204 of path 148 and cam follower 26 and corresponding housing 254 may move between bounded ends 206, 208 of path 150. As each follower 26 travels within paths 148, 150, arm 30 translates in a lateral direction 504 and arm 32 translates in an opposite lateral direction 506. As each arm 30, 32 translates, shafts 34 moves in direction 504 and shafts 36 move in direction 506. In one embodiment, shafts 34 and shafts 36 move the same distance. Pair of inner shafts 34 may be coupled to a jaw and pair of outer shafts 36 may be coupled to a jaw, such that each jaw moves toward or away from the other jaw when shafts 34 and 36 move. Assembly 10 provides a smooth and continuous opening and closing of the jaws, which may prevent wear of the jaws and reduce maintenance of the same.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

1. A cam comprising:
a body having an axis of rotation, the body having an outer surface at a diameter extending between a first end and a second end;
a first path having a first end and a second end, the first path helically disposed inward from the outer surface, around the body in a first direction, wherein the first path first end is proximate the first end of the body and the first path second end is spaced from the first path first end, and
a second path having a first end and a second end, the second path helically disposed inward from the outer surface, around the body in a second direction, wherein the second path first end is proximate the second end of the body and the second path second end is spaced from the second path first end,
wherein at least one of the first and second paths has a varying pitch angle along its length to create a variable dwell in a pair of followers engaged with the first and second paths;
wherein, for the at least one of the first and second paths, the varying pitch angle is formed by shallow portions proximate the respective first and second path ends when measured perpendicular to the axis of rotation and a comparatively steep portion between the shallow portions.

2. A cam according to claim 1, wherein the first direction is clockwise and the second direction is counterclockwise as the first and second paths extend toward the same end of the first and second ends.

3. A cam according to claim 1, wherein the varying pitch angles of the first and second paths are the same.

4. A cam according to claim 1, wherein the first and second paths have substantially the same depth.

5. A cam according to claim 1, wherein the first and second paths have substantially the same circumferential length.

6. A cam according to claim 1, wherein the first and second paths have substantially the same axial length.

7. A cam according to claim 1, further comprising at least one groove between at least a portion of at least one of the first and second paths.

8. A cam according to claim 1, wherein the first path has an end that is substantially diametrically opposite of an end of the second path.

9. A cam according to claim 1, wherein the first and second paths are substantially nonoverlapping.

10. A cam according to claim 1, further comprising a collar configured to engage a gear.

11. A drive assembly system comprising:
a cam having
a body having a length and an outer surface at a diameter extending between a first end and a second end,
a first path having a first end and a second end, the first path helically disposed inward from the outer surface, around the body in a first direction, wherein a first end of the first path is proximate the first end of the body, and
a second path having a first end and a second end, the second path helically disposed inward from the outer surface, around the body in a second direction, wherein a first end of the second path is proximate the second end of the body,
a plurality of followers configured to move within each of the first and second paths, such that each follower moves linearly along the length of the cam; and
a first support arm and a second support arm, wherein the first support arm is disposed at one side of the cam and the second support arm is disposed on a substantially opposite side of the cam;
wherein at least one of the first and second paths has a profile configured to result in a variable dwell of a respective follower proximate the first and second ends as the follower travels between the first and second ends.

12. A drive assembly system according to claim 11, further comprising at least one cam follower housing configured to couple the follower within the first path to the first support arm, and at least one cam follower housing configured to couple the follower within the second path to the second support arm.

13. A jaw drive assembly comprising:
a pair of jaws configured to translate between an open position and a closed position;
a cam having
a body having a length and an outer surface at a diameter extending between a first end and a second end,
a first path having a first end and a second end, the first path helically disposed inward from the outer surface, around the body in a first direction, wherein the first end of the first path is proximate the first end of the body and the second end of the first path is spaced from the first end, and
a second path having a first end and a second end, the second path helically disposed inward from the outer surface, around the body in a second direction, wherein a first end of the second path is proximate the second end of the body,
a follower configured to move within each of the first and second paths, such that the follower moves linearly along the length of the cam, each follower being interconnected to one jaw of the pair of jaws to move the jaw;
a first support arm and a second support arm, wherein the first support arm is disposed on one side of the cam and the second support arm is disposed on a substantially opposite side of the cam;
a first pair of shafts coupled to the first support arm configured to move in a first lateral direction; and
a second pair of shafts coupled to the second support arm configured to move in a second lateral direction that is generally opposite of the first lateral direction;
wherein at least one of the first and second paths has a varying pitch angle along its length to create a variable dwell in the pair of jaws as a respective follower moves along a respective path; and
wherein, for the at least one of the first and second paths, the varying pitch angle is formed by shallow portions proximate the respective first and second ends when measured perpendicular to the axis of rotation and a comparatively steep portion between the shallow portions.

14. A drive assembly according to claim 13, further comprising a first gear having a first diameter and a second gear having a second diameter, wherein the first diameter is about three times greater than the second diameter.

15. A drive assembly according to claim 14, further comprising a motor coupled to at least one of the cam and the second gear.

16. A drive assembly according to claim 13, wherein the first pair of shafts are spaced the same distance from the cam, and the second pair of shafts are spaced the same distance from the cam.

17. The cam of claim 1, wherein the cam is part of a cam assembly that includes a follower slidably disposed in at least one of the first and second paths.

18. The cam of claim 17, wherein the variable dwell comprises the body being configured to rotate relative to the follower without the follower moving longitudinally relative to the axis.

19. The cam of claim 13 wherein at least one of the helical paths extends at least two circumferences around the cam.

20. The cam of claim 13 wherein the cam is configured to provide a substantially constant closing force between the pair of jaws as each cam follower moves through the dwell.
